(19) United States
(12) Patent Application Publication
(10) Pub. No.: US 2002/0036043 A1
(43) Pub. Date: Mar. 28, 2002

(54) Runflat tire having a rubberized insert containing 1,6-bis(N,N'-dibenzylthiocarbamoyldithio)-hexane

(76) Inventor: Georges Marcel Victor Thielen, Schouweiler (LU)

Correspondence Address: The Goodyear Tire & Rubber Company, Patent & Trademark Department - D/823, 1144 East Market Street, Akron, OH, 44316-0001, US

(21) Appl. No.: 09/912,865

(22) Filed: Jul. 25, 2001

Related U.S. Application Data
(60) Provisional application No. 60/222,889, filed on Aug. 3, 2000.

(51) Int. Cl. B60C 17/00

(52) U.S. Cl. 152/517

(57) ABSTRACT

Runflat tires are generally made by including a stiff insert in the sidewall thereof. This insert should be as stiff as possible to help support the weight of the vehicle to which the tire is mounted in situations where there is a loss of air pressure. During periods of operation after loss of air pressure the stiff insert carries most of the load on the tire which leads to the generation of heat. Heat build-up can then lead to thermal degradation in the insert. A reduction in crosslink density and a change in the distribution of crosslink types is the result of this thermal degradation. This invention is based upon the discovery that thermal degradation in the inserts of runflat tires can be reduced by including a 1,6-bis(N,N′-dibenzylthiocarbamoyldithio)-hexane therein as an antireversion agent. This invention more specifically discloses a pneumatic tire having at least one insert to provide the tire with runflat capability wherein the insert is comprised of a rubbery polymer and 1,6-bis(N,N′-dibenzylthiocarbamoyldithio)-hexane.

The Applicants hereby incorporate by reference prior U.S. Provisional Application Serial No. 60/222,889, filed on Aug. 3, 2000.

### TECHNICAL FIELD

This invention relates to a runflat tire that is capable of being used after total loss of air pressure, other than ambient atmospheric pressure. In other words, the tire can be used in an uninflated condition, such as after being punctured.

### BACKGROUND OF THE INVENTION

Various tire constructions have been suggested for pneumatic runflat tires; that is, tires capable of being used while uninflated (with total loss of air pressure other than ambient atmospheric pressure). A vehicle equipped with such tires can continue to be driven after the tire experiences loss of pneumatic pressure, such as loss of air pressure caused by puncture or valve failure. This is highly desirable since it allows vehicles equipped with such runflat tires to continue in operation until they reach a location where the tire can be repaired or replaced. Tires of this type are sometimes also referred to as extended mobility tires (EMT).

One approach to manufacturing a pneumatic runflat tire is described in U.S. Pat. No. 4,111,249 which is entitled “Banded Tire.” This approach involves providing a hoop or annular band directly under and approximately as wide as the tread. The hoop in combination with the rest of the tire structure is reported to be capable of supporting the weight of the vehicle while the tire is in an uninflated condition. This banded tire actually tensions the ply cords even while it is in an uninflated state.

Another approach described in European Patent Publication No. 0-475-258A1 is to simply strengthen the tire sidewalls by increasing the cross-sectional thickness thereof When such tires are operated in the uninflated condition, it places the sidewalls of the tire in compression. Heat buildup can lead to tire failure in such tires due to the large amounts of rubber required to stiffen the sidewall in cases where this approach is taken. This is especially true when the tire is operated for prolonged periods at high speeds in the uninflated condition.

U.S. Pat. No. 5,368,082 discloses the first commercially accepted runflat pneumatic radial ply tire, the Eagle® GSC-EMT tire introduced by The Goodyear Tire & Rubber Company. This tire was accepted as an equipment option for the 1994 Chevrolet Corvette automobile. U.S. Pat. No. 5,368,082 teaches the employment of special sidewall inserts to improve stiffness. Approximately six additional pounds (6.7 kg) of weight per tire was required to support an 800-lb (363 kg) load on this uninflated tire. These runflat tires had a very low aspect ratio. This earlier invention, although superior to prior attempts, still imposed a weight penalty per tire that could be offset by the elimination of a spare tire and the tire jack. This weight penalty was even more problematic when engineers attempted to build higher aspect ratio tires for large luxury touring sedans. The required supported weight for an uninflated luxury car tire approximates 1400 pounds (610 kg) of load. These taller sidewalled tires having aspect ratios in the 55 percent to 65 percent range or greater means that the working loads were several times that of the earlier 40 percent aspect ratio runflat tires developed for the Corvette automobile. Such loads meant that the sidewalls and overall tire had to be stiffened to the point of compromising ride. Luxury vehicle owners simply will not sacrifice ride quality for runflat capability.

The goal of engineering has been to develop a runflat tire without compromising ride or performance. In sports cars having relatively stiff suspension characteristics, the ability to provide such a runflat tire was comparatively easy as compared to providing such tires for luxury sedans that demand softer ride characteristics. Light truck and sport utility vehicles, although not as sensitive to ride performance, typically utilize tires having a relatively high aspect ratio which makes the requirements for the runflat tire more challenging.

An equally important design consideration in the development of a runflat tire is insuring that the uninflated tire remains seated on the rim. Solutions have been developed employing bead restraining devices as well as special rims to accomplish this requirement. Alternatively, the Eagle GSC-EMT tire employed a new bead configuration enabling the tire to function on standard rims without requiring additional bead restraining devices.

U.S. Pat. Nos. 5,427,166 and 5,511,599 disclose tires wherein a third ply and a third insert in the sidewall are used to further increase runflat performance over a basic design disclosed in U.S. Pat. No. 5,368,082. These patents disclose the concept of including additional plies and inserts in a tire sidewall to attain improved runflat performance characteristics.

U.S. Pat. No. 5,685,927 discloses a runflat tire which provides a higher aspect ratio with the employment of load-supporting bead cores placed directly under the tread belt package of the tire. Runflat tires made utilizing this approach are very promising in load support and ride quality. However, this approach leads to higher rolling resistance which decreases fuel economy even during periods when the tire is used under normal conditions at standard inflation pressure.

U.S. Pat. No. 5,535,800 discloses the use of elastomeric-covered composite ribs that in combination with a radial ply can provide excellent runflat capability in a wide range of tire applications.

In the case of runflat tires made utilizing stiff inserts, the insert carries most of the load on the tire during periods of operation after loss of air pressure. This leads to the generation of heat. Heat build-up can then lead to thermal degradation in the insert. A reduction in crosslink density and a change in the distribution of crosslink types is the result of this thermal degradation. Thermal degradation can accordingly lead to failure of the insert. This failure limits the range over which the runflat tire can be used during periods of operation after air loss.

### SUMMARY OF THE INVENTION

This invention is based upon the discovery that thermal degradation in the rubber inserts of runflat tires can be inhibited by incorporating 1,6-bis(N,N′-dibenzylthiocarbamoyldithio)-hexane. This runflat tire has an extended service life while being operated in the uninflated state.

### BRIEF DESCRIPTION OF THE DRAWINGS

FIG. 1 is a fragmentary cross-sectional view of a tire showing its tread and carcass with one ply and one insert axially inward of the ply in the sidewall region of the tire as an embodiment of the invention.

FIG. 2 is a fragmentary cross-sectional view of a tire showing its tread and carcass with two plies, a second insert interposed between the plies and a second ply axially outward of the innermost ply in the sidewall region of the tire as an embodiment of the invention.

FIG. 3 is a fragmentary cross-sectional view of a tire showing its tread and carcass with three plies, inserts between the plies and another insert axially inward of the innermost ply in the sidewall region of the tire as an embodiment of the invention.

### DEFINITIONS

“Axial” and “axially,” where used, means directions that are parallel to the axis of rotation of the tire.

“Bead portion” means generally that part of the tire comprising an annular inextensible tensile member such as a multiplicity of annular wires surrounded by an elastomer composition(s) and is associated with holding the tire to the rim being wrapped by ply cords and shaped, with or without other reinforcement elements such as flippers, chippers, apexes or fillers, toe guards and chaffers. The bead core usually refers to the wire beads of the bead portion but sometimes may refer to the bead portion itself.

“Belt Structure” or “Reinforcing Belts,” where used, means at least two annular layers or plies of parallel cords, woven or unwoven, underlying the tread, unanchored to the bead and having both left and right cord angles in the range from 17° to 27° with respect to the equatorial plane of the tire.

“Circumferential” may be used in the description to relate to a direction extending along (around) the outer perimeter of the surface of the tire carcass such as, for example, the circumferential tread on the carcass.

“Carcass” means the tire structure apart from the tread but including supporting plies, sidewalls and the beads or bead portions.

“Chafers,” where used herein, refers to narrow strips of material placed around the outside of the bead to protect cord plies from the rim and distribute flexing above the rim.

“Cord” means one of the reinforcement strands of which the plies in the tire are comprised.

“Innerliner,” where used herein, means the layer or layers of elastomer or other material that form the inside surface of a tubeless tire and that contain the inflating fluid within the tire.

“Ply” means a layer of rubber-coated parallel cords.

“Radial” and “radially” mean directions radially toward or away from the axis of rotation of the tire.

“Radial Ply Tire,” if used herein, means a belted or circumferentially-restricted pneumatic tire in which at least one ply has cords which extend from bead to bead are laid at cord angles between 65° and 90° with respect to the equatorial plane of the tire.

“Shoulder,” if used herein, means the upper portion of sidewall just below the tread edge.

“Sidewall” means that portion of a tire between the tread and the bead.

### DETAILED DESCRIPTION OF THE INVENTION

There is disclosed a runflat tire which is comprised of a generally toroidal-shaped carcass with an outer circumferential tread-two spaced beads, a radial ply structure extending from bead to bead and sidewalls extending radically from and connecting said tread to said beads, wherein said tread is adopted to be ground contacting and said sidewalls contain at least one insert radically inward from said ply and wherein the insert is comprised of a rubbery polymer and 1,6-bis(N,N′-dibenzylthiocarbamoyldithio)-hexane.

The tire inserts used in the present invention contain a rubbery polymer or elastomers containing olefinic unsaturation. The phase “rubbery polymer, rubber or elastomer containing olefinic unsaturation” is intended to include both natural rubber and its various raw and reclaim forms as well as various synthetic rubbers. In the description of this invention, the terms “rubber”, “rubbery polymer” and “elastomer” may be used interchangeably, unless otherwise prescribed. The terms “rubber composition”, “compounded rubber” and “rubber compound” are used interchangeably to refer to rubber which has been blended or mixed with various ingredients and materials and such terms are well known to those having skill in the rubber mixing or rubber compounding art. Representative synthetic polymers are the homopolymerization products of butadiene and its homologues and derivatives, for example, methylbutadiene, dimethylbutadiene and pentadiene as well as copolymers such as those formed from butadiene or its homologues or derivatives with other unsaturated monomers. Among the latter are acetylenes, for example, vinyl acetylene; olefins, for example, isobutylene, which copolymerizes with isoprene to form butyl rubber; vinyl compounds, for example, acrylic acid, acrylonitrile (which polymerize with butadiene to form NBR), methacrylic acid and styrene, the latter compound polymerizing with butadiene to form SBR, as well as vinyl esters and various unsaturated aldehydes, ketones and ethers, e.g. acrolein, methyl isopropenyl ketone and vinylethyl ether. Specific examples of synthetic rubbers include neoprene (polychloroprene), polybutadiene (including cis 1,4-polybutadiene used alone or masterbatched with syndiotactic 1,2-polybutadiene) polyisoprene (including cis 1,4-polyisoprene), butyl rubber, halobutyl rubber such as chlorobutyl rubber or bromobutyl rubber styrene, acrylonitrile and methyl methacrylate, as well as ethylene/propylene terpolymers, also known as ethylene/propylene/diene monomer (EPDM), and in particular, ethylene/propylene/dicyclopentadiene terpolymers. Additional examples of rubbers which may be used include rubbers coupled with a Group IVa metal. The preferred rubber or elastomers are polybutadiene and SBR.

In one aspect the rubber is preferably of at least two of diene based rubbers. For example, a combination of two or more rubbers is preferred such as cis 1,4-polyisoprene rubber (natural or synthetic, although natural is preferred), 3,4-polyisoprene rubber, styrene/isoprene/butadiene rubber, isoprene/butadiene rubber, emulsion and solution polymerization derived styrene/butadiene rubbers, cis 1,4-polybutadiene rubbers and emulsion polymerization prepared butadiene/acrylonitrile copolymers. In some cases, it is preferred to use a blend of natural rubber and high cis 1,4-polybutadiene rubber. Such blends will typically contain 20 to 50 phr of natural rubber and 50 to 80 phr of high cis 1,4-polybutadiene . Blends of this type will preferably contain 25 phr to 40 phr of natural rubber and 60 to 75 phr of high cis 1,4-polybutadiene rubber.

The solution polymerization prepared SBR (S-SBR) typically has a bound styrene content in a range of about 5 to about 50, preferably about 9 to about 36, percent. The S-SBR can be conveniently prepared, for example, by organo lithium catalyzation in the presence of an organic hydrocarbon solvent.

The syndiotactic 1,2-polybutadiene that may be used can be obtained from UBE Industries under the designation Ubepol® VCR 412 and Ubepol® VCR 617. These products are masterbatches of syndiotactic and cis 1,4-polybutadiene.

A particularly preferred isoprene/butadiene rubber has a Tg ranging from −90° C. to −60° C.

The 3,4-polyisoprene rubber (3,4-PI) is considered beneficial when it is used in an insert. The 3,4-PI and use thereof is more fully described in U.S. Pat. No. 5,087,668 which is incorporated herein by reference. The Tg refers to the glass transition temperature which can conveniently be determined by a differential scanning calorimeter at a heating rate of 10° C. per minute.

The cis 1,4-polybutadiene rubber (BR) is considered to be beneficial for use in an insert. Such BR can be prepared, for example, by organic solution polymerization of 1,3-butadiene. The BR may be conveniently characterized, for example, by having at least a 90 percent cis 1,4-content.

The cis 1,4-polyisoprene and cis 1,4-polyisoprene natural rubber are well known to those having sill in the rubber art.

The rubber coupled with a group IVa metal can be made by anionic polymerization wherein the polymerization is terminated by the addition of a Group IVa metal coupling agent, such as a tin tetrahalide. The anionic polymerization is initiated with a Group I or II metal, such as lithium, and is carried out for a length of time sufficient to permit substantially complete polymerization of monomers. In other words, the polymerization is normally carried out until high conversions are attained. Then, the coupling agent is added to couple the living rubbery polymer which, of course, terminates the polymerization.

The coupling agent will typically be group IV a metal halide, such as a tin halide, a lead halide, a germanium halide or a silicon halide. The halogen in the coupling agent will typically be fluorine, chlorine, bromine or iodine. In most cases, the halogen will be selected from the group consisting of fluorine, chlorine and bromine with chlorine being preferred. Tin coupling agents, such as tin tetrachloride, tin tetrabromide, tin tetrachloride and tin tetraiodide are normally preferred. The coupling agent will normally be a tetrahalide. However, trihalides or dihalides can also be used. In cases where tin dihalides are utilized, a linear polymer rather than a branched polymer results. To induce a higher level of branching, tin tetrahalides are normally preferred.

Broadly, and exemplarily, a range of about 0.01 to 4.5 milliequivalents of the coupling agent is employed per 100 grams of the rubbery monomer. It is normally preferred to utilize about 0.01 to about 1.5 milliequivalents of the coupling agent per 100 grams of monomer to obtain the desired Mooney viscosity. The larger quantities tend to result in production of polymers containing terminally reactive groups or insufficient coupling. One equivalent of tin coupling agent per equivalent of lithium is considered an optimum amount for maximum branching. For instance, if a tin tetrahalide is used as the coupling agent, one mole of the tin tetrahalide would be utilized per four moles of live lithium ends. In cases where a tin trihalide is used as the coupling agent, one mole of the tin trihalide will optimally be utilized for every three moles of live lithium ends. The tin coupling agent can be added to a polymer cement containing the living rubbery polymer in a hydrocarbon solution, e.g., in cyclohexane, with suitable mixing for distribution and reaction.

The coupled rubbery polymer that can optionally be utilized in the tire insert compositions of this invention can be symmetrically or asymmetrically coupled. A technique for preparing asymmetrically tin-coupled rubbery polymers is disclosed in U.S. Pat. No. 6,043,321, the teachings of which are incorporated herein by reference in their entirety. In this process, asymmetrical tin-coupled rubbery polymer having improved stability are made by a process that comprises:

(1) continuously polymerizing in a first reactor at least one diene monomer to a conversion of at least about 90 percent, utilizing an anionic initiator to produce a polymer cement containing living polydiene rubber chains;

(2) continuously feeding the polymer cement produced in the first reactor into a second reactor;

(3) adding a tin halide to the polymer cement in a second reactor under conditions of agitation to produce a polymer cement having the tin halide homogeneously dispersed therein, wherein the residence time in the second reactor is within the range of about 15 minutes to about 4 hours;

(4) continuously feeding the polymer cement having the tin halide homogeneously dispersed therein into a plug flow reactor having a residence time of about 15 minutes to about 1 hour to produce a polymer cement of the asymmetrically tin-coupled rubbery polymer; and

(5) continuously withdrawing the polymer cement of the asymmetrically tin-coupled rubbery polymer from the plug flow reactor.

Some representative examples of rubbery polymers which can be asymmetrically tin-coupled include polybutadiene, polyisoprene, styrene-butadiene rubber (SBR), α-methylstyrene-butadiene rubber, α-methylstyrene-isoprene rubber, styrene-isoprene-butadiene rubber (SIBR), styrene-isoprene rubber (SIR), isoprene-butadiene rubber (IBR), α-methylstyrene-isoprene-butadiene rubber and α-methylstyrene-styrene-isoprene-butadiene rubber.

A critical aspect of the present invention is the use of 1,6-bis(N,N′-dibenzylthiocarbamoyldithio)-hexane. This chemical is available from Bayer under the designation Vulcuren® VPKA 9188. Vulcuren® VPKA 9188 contains 1,6-bis(N,N′-dibenzylthiocarbamoyldithio)-hexane, which is coated with mineral oil to reduce dust formation.

The level of 1,6-bis(N,N′-dibenzylthiocarbamoyldithio)-hexane that is used in the rubber insert may vary. Generally speaking, it will be present in an amount ranging from 0.1 to 10 phr. Preferably it is used in an amount ranging from 0.5 to 2.5 phr.

The rubber composition for use in the insert may optionally contain a conventional sulfur containing organosilicon compound. Examples of suitable sulfur containing organosilicon compounds are of the formula:

Z-Alk-Sₙ-Alk-Z

in which Z is selected from the group consisting of

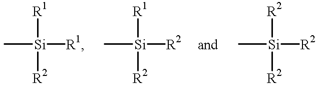

where R¹ is an alkyl group of 1 to 4 carbon atoms, cyclohexyl or phenyl; R² is alkoxy of 1 to 8 carbon atoms, or cycloalkoxy of 5 to 8 carbon atoms; Alk is a divalent hydrocarbon of 1 to 18 carbon atoms and n is an integer of 2 to 8.

Specific examples of sulfur containing organosilicon compounds which may be used in accordance with the present invention include: 3,3′-bis(trimethoxysilylpropyl)disulfide, 3,3′-bis(triethoxysilylpropyl)disulfide, 3,3′-bis(triethoxysilylpropyl)tetrasulfide, 3,3′-bis(triethoxysilylpropyl)octasulfide, 3,3′-bis(trimethoxysilylpropyl)tetrasulfide, 2,2′-bis(triethoxysilylethyl)tetrasulfide, 3,3′-bis(trimethoxysilylpropyl)trisulfide, 3,3′-bis(triethoxysilylpropyl)trisulfide, 3,3′-bis(tributoxysilylpropyl)disulfide, 3,3′-bis(trimethoxysilylpropyl)hexasulfide, 3,3′-bis(trimethoxysilylpropyl)octasulfide, 3,3′-bis(trioctoxysilylpropyl)tetrasulfide, 3,3′-bis(trihexoxysilylpropyl)disulfide, 3,3′-bis(tri-2″-ethylhexoxysilylpropyl)trisulfide, 3,3′-bis(triisooctoxysilylpropyl)tetrasulfide, 3,3′-bis(tri-t-butoxysilylpropyl)disulfide, 2,2′-bis(methoxy diethoxy silyl ethyl)tetrasulfide, 2,2′-bis(tripropoxysilylethyl)pentasulfide, 3,3′-bis(tricyclonexoxysilylpropyl)tetrasulfide, 3,3′-bis(tricyclopentoxysilylpropyl)trisulfide, 2,2′-bis(tri-2″-methylcyclohexoxysilylethyl)tetrasulfide, bis(trimethoxysilylmethyl)tetrasulfide, 3-methoxy ethoxy propoxysilyl 3′-diethoxybutoxy-silylpropyltetrasulfide, 2,2′-bis(dimethyl methoxysilylethyl)disulfide, 2,2′-bis(dimethyl sec.butoxysilylethyl)trisulfide, 3,3′-bis(methyl butylethoxysilylpropyl)tetrasulfide, 3,3′-bis(di t-butylmethoxysilylpropyl)tetrasulfide, 2,2′-bis(phenyl methyl methoxysilylethyl)trisulfide, 3,3′-bis(diphenyl isopropoxysilylpropyl)tetrasulfide, 3,3′-bis(diphenyl cyclohexoxysilylpropyl)disulfide, 3,3′-bis(dimethyl ethylmercaptosilylpropyl)tetrasulfide, 2,2′-bis(methyl dimethoxysilylethyl)trisulfide, 2,2′-bis(methyl ethoxypropoxysilylethyl)tetrasulfide, 3,3′-bis(diethyl methoxysilylpropyl)tetrasulfide, 3,3′-bis(ethyl di-sec. butoxysilylpropyl)disulfide, 3,3′-bis(propyl diethoxysilylpropyl)disulfide, 3,3′-bis(butyl dimethoxysilylpropyl)trisulfide, 3,3′-bis(phenyl dimethoxysilylpropyl)tetrasulfide, 3-phenyl ethoxybutoxysilyl 3′-trimethoxysilylpropyl tetrasulfide, 4,4′-bis(trimethoxysilylbutyl)tetrasulfide, 6,6′-bis(triethoxysilylhexyl)tetrasulfide, 12,12′-bis(triisopropoxysilyl dodecyl)disulfide, 18,18′-bis(trimethoxysilyloctadecyl)tetrasulfide, 18,18′-bis(tripropoxysilyloctadecenyl)tetrasulfide, 4,4′-bis(trimethoxysilyl-buten-2-yl)tetrasulfide, 4,4′-bis(trimethoxysilylcyclohexylene)tetrasulfide, 5,5′-bis(dimethoxymethylsilylpentyl)trisulfide, 3,3′-bis(trimethoxysilyl-2-methylpropyl)tetrasulfide, 3,3′-bis(dimethoxyphenylsilyl-2-methylpropyl)disulfide.

The preferred sulfur containing organosilicon compounds are the 3,3′-bis(trimethoxy or triethoxy silylpropyl)sulfides. The most preferred compounds are 3,3′-bis(triethoxysilylpropyl)disulfide and 3,3′-bis(triethoxysilylpropyl)tetrasulfide. Therefore as to the above formula, preferably Z is

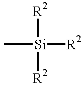

where R² is an alkoxy of 2 to 4 carbon atoms, with 2 carbon atoms being particularly preferred; alk is a divalent hydrocarbon of 2 to 4 carbon atoms with 3 carbon atoms being particularly preferred; and n is an integer of from 2 to 5 with 2 and 4 being particularly preferred.

The amount of the sulfur containing organosilicon compound in the rubber composition for use as an insert will vary depending on the level of other additives that are used. Generally speaking, the amount of the sulfur containing organosilicon compound will range from 0.5 to 20 phr. Preferably, the amount will range from 1 to 10 phr.

Generally speaking, conventional fillers may be also present in the rubber used in the insert. The amount of such conventional fillers may range from 10 to 130 phr. Preferably, the filler is present in an amount ranging from 35 to 65 phr.

The commonly employed siliceous pigments which may be used in the rubber compound for the insert include conventional pyrogenic and precipitated siliceous pigments (silica), although precipitated silicas are preferred. The conventional siliceous pigments preferably employed in this invention are precipitated silicas such as, for example, those obtained by the acidification of a soluble silicate, e.g., sodium silicate.

Such conventional silicas might be characterized, for example, by having a BET surface area, as measured using nitrogen gas, preferably in the range of about 40 to about 600, and more usually in a range of about 50 to about 300 square meters per gram. The BET method of measuring surface area is described in the Journal of the American Chemical Society, Volume 60, Page 304 (1930).

The conventional silica may also be typically characterized by having a dibutylphthalate (DBP) absorption value in a range of about 100 to about 400, and more usually about 150 to about 300.

The conventional silica might be expected to have an average ultimate particle size, for example, in the range of 0.01 to 0.05 micron as determined by the electron microscope, although the silica particles may be even smaller, or possibly larger, in size.

Various commercially available silicas may be used, such as, only for example herein, and without limitation, silicas commercially available from PPG Industries under the Hi-Sil trademark with designations 210, 243, etc; silicas available from Rhone-Poulenc, with, for example, designations of Z85MP, Z1115MP, Z1165MP and Z165GR and silicas available from Degussa AG with, for example, designations VN2 and VN3, etc.

Commonly employed carbon blacks can be used as a conventional filler. Representative examples of such carbon blacks include N110, N121, N220, N231, N234, N242, N293, N299, S315, N326, N330, M332, N339, N343, N347, N351, N358, N375, N539, N550, N582, N630, N642, N650, N660, N683, N754, N762, N765, N774, N787, N907, N908, N990 and N991. These carbon blacks have iodine absorptions ranging from 9 to 145 g/kg and DBP No. ranging from 34 to 150 cm3/100 g.

It is readily understood by those having skill in the art that the rubber composition would be compounded by methods generally known in the rubber compounding art, such as mixing the various sulfur-vulcanizable constituent rubbers with various commonly used additive materials such as, for example, sulfur, sulfur donors, curing aids, such as activators and retarders and processing additives, such as oils, resins including tackifying resins and plasticizers, fillers, pigments, fatty acid, zinc oxide, waxes, antioxidants and antiozonants and peptizing agents. As known to those skilled in the art, depending on the intended use of the sulfur vulcanizable and sulfur vulcanized material (rubbers), the additives mentioned above are selected and commonly used in conventional amounts. Representative examples of sulfur donors include elemental sulfur (free sulfur), an amine disulfide, polymeric polysulfide and sulfur olefin adducts. Preferably, the sulfur vulcanizing agent is elemental sulfur. The sulfur vulcanizing agent may be used in an amount ranging from 0.5 to 8 phr, with a range of from 1.5 to 6 phr being preferred. Typical amounts of tackifier resins, if used, comprise about 0.5 to about 10 phr, usually about 1 to about 5 phr. Typical amounts of processing aids comprise about 1 to about 10 phr. Such processing aids can include, for example, aromatic, naphthenic, and/or paraffinic processing oils. Typical amounts of antioxidants comprise about 1 to about 5 phr. Representative antioxidants may be, for example, diphenyl-p-phenylenediamine and others, such as, for example, those disclosed in The Vanderbilt Rubber Handbook (1978), Pages 344 through 346. Typical amounts of antiozonants comprise about 1 to 5 phr. Typical amounts of fatty acids, if used, which can include stearic acid comprise about 0.5 to about 3 phr. Typical amounts of zinc oxide comprise about 2 to about 5 phr. Typical amounts of waxes comprise about 1 to about 5 phr. Often microcrystalline waxes are used. Typical amounts of peptizers comprise about 0.1 to about 1 phr. Typical peptizers may be, for example, pentachlorothiophenol and dibenzamidodiphenyl disulfide.

Accelerators are used to control the time and/or temperature required for vulcanization and to improve the properties of the vulcanizate. In one embodiment, a single accelerator system may be used, i.e., primary accelerator. The primary accelerator(s) may be used in total amounts ranging from about 0.5 to about 4, preferably about 0.8 to about 2.5, phr. In another embodiment, combinations of a primary and a secondary accelerator might be used with the secondary accelerator being used in smaller amounts, such as from about 0.05 to about 3 phr, in order to activate and to improve the properties of the vulcanizate. Combinations of these accelerators might be expected to produce a synergistic effect on the final properties and are somewhat better than those produced by use of either accelerator alone. In addition, delayed action accelerators may be used which are not affected by normal processing temperatures but produce a satisfactory cure at ordinary vulcanization temperatures. Vulcanization retarders might also be used. Suitable types of accelerators that may be used in the present invention are amines, disulfides, guanidines, thioureas, thiazoles, thiurams, sulfenamides, dithiocarbamates and xanthates. Preferably, the primary accelerator is a sulfenamide. If a second accelerator is used, the secondary accelerator is preferably a guanidine, dithiocarbamate or thiuram compound.

The mixing of the rubber composition for use in the insert can be accomplished by methods known to those having skill in the rubber mixing art. For example the ingredients are typically mixed in at least two stages, namely at least one non-productive stage followed by a productive mix stage. The final curatives including sulfur vulcanizing agents are typically mixed in the final stage which is conventionally called the “productive” mix stage in which the mixing typically occurs at a temperature, or ultimate temperature, lower than the mix temperature(s) than the preceding non-productive mix stage(s). The rubber and the 1,6-bis(N,N′-dibenzylthiocarbamoyldithio)-hexane are mixed in the productive mix stage. The terms “non-productive” and “productive” mix stages are well known to those having skill in the rubber mixing art. The 1,6-bis(N,N′-dibenzylthiocarbamoyldithio)-hexane may be added as a separate ingredient or in the form of a masterbatch. The rubber composition containing the 1,6-bis(N,N′-dibenzylthiocarbamoyldithio)-hexane as well as the sulfur-containing organosilicon compound, if used, be subjected to a thermomechanical mixing step. The thermomechanical mixing step generally comprises a mechanical working in a mixer or extruder for a period of time suitable in order to produce a rubber temperature between 140° C. and 190° C. The appropriate duration of the thermomechanical working varies as a function of the operating conditions and the volume and nature of the components. For example, the thermomechanical working may be from 1 to 20 minutes.

Tires containing the inserts of this invention can be comprised of a toroidally-shaped carcass and an outer, circumferential tread designed to be ground-contacting, wherein said carcass is comprised of two spaced-apart inextensible bead portions, two spaced-apart sidewalls each individually extending radially inward from and connecting said tread to said bead potions and at least one cord reinforced ply extending from bead to bead and through the sidewalls; an improvement in which a substantially crescent-shaped rubber insert is juxtapositioned to and axially inward of at least one of said carcass plies in each of said sidewalls of the tire.

It is to be appreciated that the insert is sulfur co-cured with the tire assembly of said tread and carcass as a whole. Preferably, the insert(s) have a maximum thickness at a location about midway between the bead portions and the tread in the sidewall region of the tire.

In the practice of this invention, a significant function of the rubber composition-based fillers in the sidewall portion of the tire is to stiffen/support the sidewall structure when the tire is operated without inflation pressure.

The rubber composition-based inserts are elastomeric in nature having a substantially crescent cross-sectional shape and material properties selected to enhance inflated ride performance while promoting the tire's run-flat durability. The inserts, if desired, may also be individually reinforced with cords or short fibers. Thus, one or more of such inserts may be so-reinforced.

The shape of the insert is described as being substantially crescent in shape. This is intended to also include an entrunkated crescent shape, particularly where the entrunkated portion of the crescent-shaped insert is juxtapositioned to the tire's bead portion.

In further practice of the invention, said tire carcass may have from one to three plies comprised of a first axially inner ply and optionally one or two additional plies as a second ply and third ply, respectively; each additional ply positioned sequentially axially outward from said first ply in the sidewall region of the tire.

Accordingly, in accordance with this invention, said tire contains one ply in its carcass wherein said insert is juxtapositioned to and axially inward of said ply in the sidewall region of the tire.

In further accordance with this invention, said tire contains, in its carcass, an axially inner first ply and a second ply axially outward from the first ply; wherein said insert is juxtapositioned to and axially inward of said first ply, in the sidewall region of the tire.

In additional accordance with this invention, said tire contains, in its carcass, an axially inner first ply and an axially outer second ply; wherein said insert is juxtapositioned to and interposed between said first and second ply, in the sidewall region of the tire.

In further accordance with this invention, said tire contains, in its carcass, an axially inner first ply and an axially outer second ply; wherein one of said inserts is juxtapositioned to and interposed between said first and second ply, in the sidewall region of the tire, and another of said inserts is juxtapositioned to and axially inward of said first ply, in the sidewall region of the tire.

In further accordance with this invention, said tire contains, in its carcass, an axially inner first ply, a second ply axially outward from said first ply and a third ply axially outward from said second ply; wherein said insert is juxtapositioned to and axially inward of said first ply, in the sidewall region of the tire.

In additional accordance with this invention, said tire contains, in its carcass, an axially inner first ply, a second ply axially outward from said first ply and a third ply axially outward from said second ply; wherein said insert is juxtapositioned to and interposed between (a) said first and second plies and/or (b) said second and third plies, in the sidewall region of the tire.

In further accordance with this invention, said tire contains, in its carcass, an axially inner first ply, a second ply axially outward from said first ply and a third ply axially outward from said second ply; wherein said insert is juxtapositioned to and interposed between (a) said first and second plies and/or (b) said second and third plies, in the sidewall region of the tire and, also, an insert juxtapositioned to and axially inward of the innermost of said plies.

In one embodiment, the innermost ply, or plies, has synthetic or textile cord reinforcement of polyester, nylon, rayon or aramid, preferably nylon; while the outermost ply preferably has aramid, rayon, carbon fiber, fiberglass or metal cord reinforcement, preferably brass and/or zinc-coated steel cords.

Thus, in a preferred embodiment, the first ply has reinforcing cords of rayon and the second and additional plies are cords of rayon.

The term “ply” is contemplated to include cord reinforced inserts which do not extend entirely from one bead core to the opposite bead core. It is, however, contemplated that at least one ply must extend from bead core to the opposite bead core, preferably a radial ply. A second ply can extend from a bead core to just laterally under one or more of the reinforcing belts of the belt structure.

In one aspect, the outermost ply preferably has cords of a higher modulus (i.e., steel cords) and the innermost ply, or plies, have cords of a lower modulus (i.e., nylon or rayon).

At least one ply, preferably the innermost ply, extended from bead core to bead cord and wraps around the bead core. Alternatively, where two or more plies are used, at least one of the additional plies, while extending from bead core to bead core, does not actually wrap around the bead core.

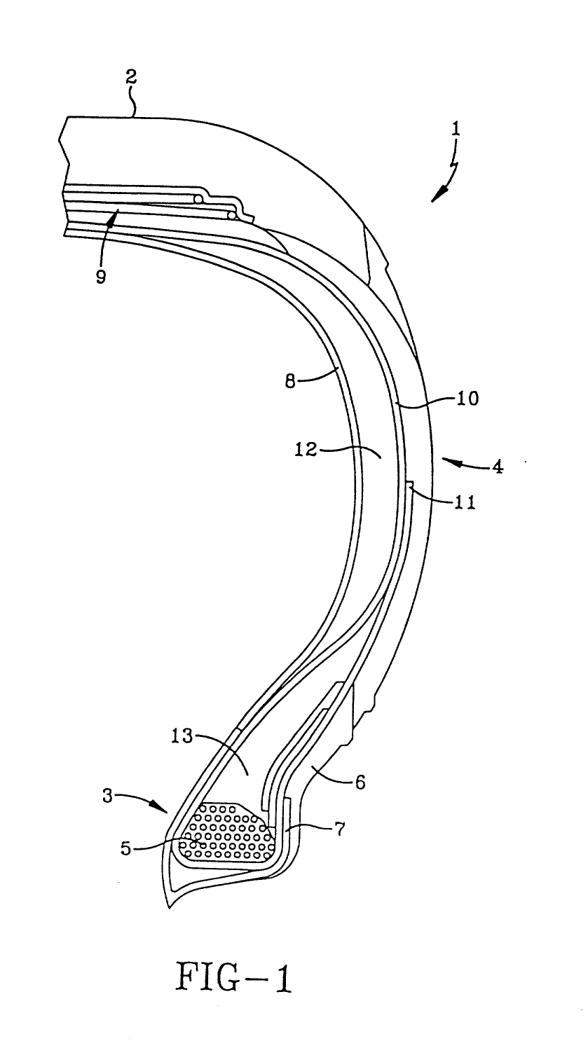

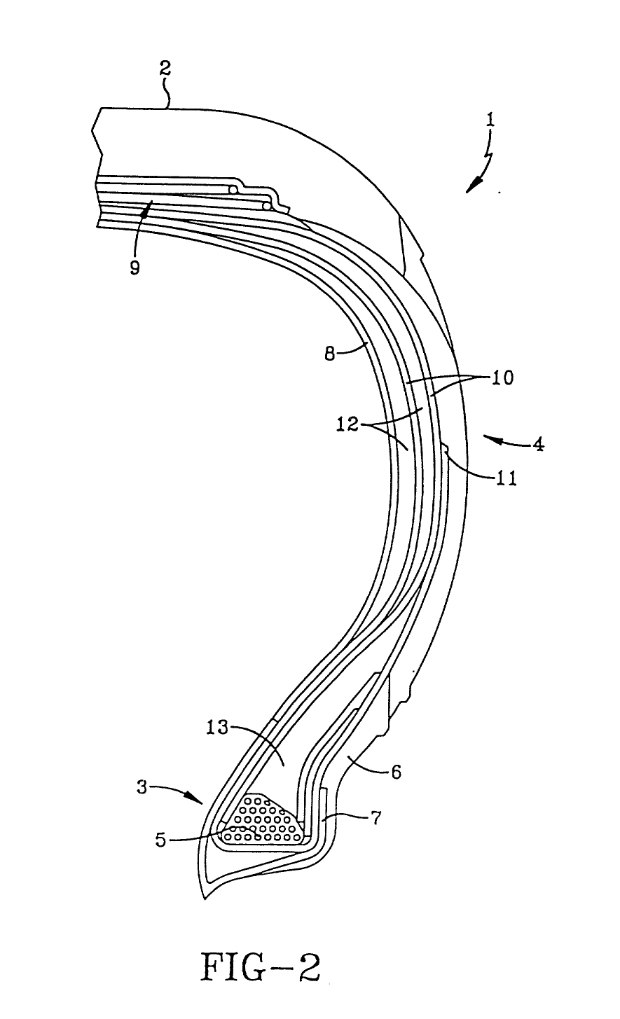

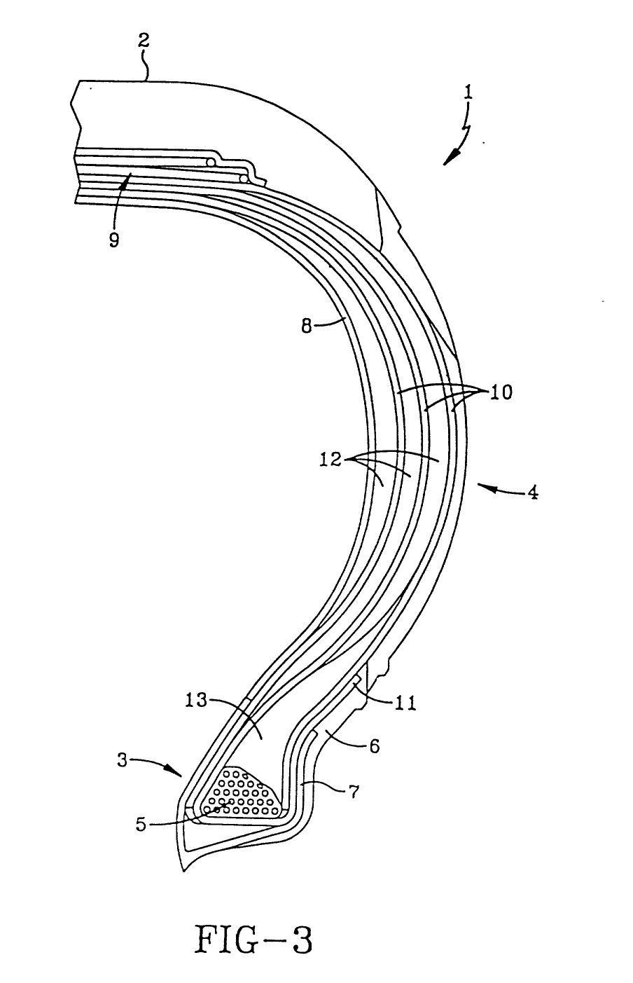

Referring to the drawings, FIGS. 1, 2 and 3 show the fragmentary cross-section of a tire 1, its tread 2, bead portion 3, sidewall or sidewall region 4, inextensible wire bead core 5, rubber chafer 6, rubber toeguard 7, rubber composition innerliner 8, belt structure 9 underlying a portion of the tread 2, carcass ply 10, carcass ply turnup 11, insert 12 and apex 13.

The cords for use in the carcass plies may comprise from one (monofilament) to multiple twisted filaments. The number of total filaments in the cord may range from 1 to 13. The cords, particularly metallic cords, of the carcass ply are generally oriented such that the tire according to the present invention is what is commonly referred to as a radial.

The cord of the carcass ply intersect the equatorial plane (EP) of the tire at an angle in the range of from 75° to 105°, Preferably, the cords intersect at an angle of from 82° to 98°. A more preferred range is from 89° to 91°.

The first and second reinforcing ply structure each may comprise a single ply layer; however, any number of carcass plies may be used. As further illustrated in the Figures, the first ply structure has a pair of turnup ends respectively which wrap about each bead core 5 of the bead portion 3 of the carcass. The ends 11 of the second ply 10 are in proximity to the bead core 5 and terminate radially adjacent on either side of the bead core 5, above the bead core 5 or can be wrapped around the bead core 5 and terminates radially below the turnup end 11 of the first ply 10 as shown. The turnup ends 11 of the first ply 10 wrap about the second ply ends and the bead core 5. The turnup ends of the first ply 11 terminates radially a distance above the nominal rim diameter of the tire 1 in proximity to the radial location of the maximum section width of the tire. In a preferred embodiment, the turnup ends are located within 20 percent of the section height of the tire from the radial location of the maximum section width, most preferably terminating at the radial location of the maximum section width.

The bead core 5 is preferably constructed of a single or monofilament steel wire continuously wrapped. Located within the bead region 3 and the radially inner portions of the sidewall portions 4 are high modulus elastomeric apex inserts disposed between carcass reinforcing structure 11 and the turnup ends 11, respectively. The elastomeric apex inserts 13 extend from the radially outer portion of bead portions respectively, up into the sidewall portion gradually decreasing in cross-sectional width. The elastomeric apex inserts 13 terminate at a radially outer end.

The inserts 12 may extend from each bead region radially to the edge of the tread, usually to just beneath the reinforcing belt structures 9. As illustrated in the Figures, the sidewall portions may each include a first insert 12 and a second insert 12 and even a third insert 12. The first inserts 12 are positioned as described above. The second inserts 12 are located (interposed) between the first and the second plies 10, respectively. The second insert 12 extends from each bead region 3, or portion, radially outward to the edge of the tread 2, namely, to just beneath the reinforcing belt structure 9.

In one embodiment, the first inserts 10 each have a thickness at its maximum thickness of at least three percent of the maximum section height “SH” at a location approximately radially aligned to the maximum section width of the tire.

The second insert, and third insert, if used, has a thickness at its maximum thickness of at least one and one-half percent (1.5%) of the maximum section height of the tire at the location radially above the maximum section width of the tire. In a preferred embodiment, the elastomeric second inserts, and third insert, if used, each have a thickness of approximately one and one-half percent (1.5%) of the maximum section height SH of the tire at a radial location of about 75 percent of the section height SH. For example, in a P275/40ZR17-size high performance tire, this thickness of the second insert of the tire equals 0.08 inches (2 mm). At the location approximately radially aligned with the location of the maximum section width of the tire, the thickness of the second insert is 0.05 inches (1.3 mm).

The overall cross-sectional thickness of the combination of elastomeric inserts preceding from the bead portions to the radial location of the maximum section width (SW) is preferably of constant thickness. The overall sidewall and carcass thickness is at least 0.45 inches (11.5 mm) at the maximum section width location and increases to an overall thickness in the region where it merges into the shoulder near the lateral tread edges. Preferably, the overall thickness of the sidewall in the shoulder region of the tire is at least one hundred percent (100%) of the overall sidewall thickness at the maximum section width (SW). This ratio means that the sidewall can be made substantially thinner than the predecessor-type runflat tires.

As previously discussed, the tire of the present invention has at least one ply having a turnup end 11 (wrapped around the bead core 5) while another ply can simply be terminated adjacent to the bead core 5 without actually wrapping around the bead core 5.

The first insert 12 is preferably made of elastomeric material. The first insert 12 is designed to prevent the tire's sidewall from collapsing when operating under no inflation pressure. The insert 12 can be of a wide range of shore A hardnesses from a relative soft shore A of about 50 to very hard 85, and preferably from 70 to 80. The material shape and cross-sectional profile is modified to insure the ride performance and sidewall spring rate is acceptable. The cross-sectional area of the insert can be reduced without compromising performance characteristics by utilizing stiffer materials in the insert. Thus, weight can be reduced by using stiffer materials in the insert.

The second insert 12, and third insert 12, if used, can be of the same or different material physical properties relative to the first insert. This means that the combination of a hard second insert 12, and/or third insert 12, if used, with a softer first insert 12 is contemplated as well as the combination of a hard first insert 12 with a softer second and/or third insert 12. The elastomeric materials of the second insert may similarly be in the 50 to 85 shore A range.

The second insert 12 and third insert 12, if used, as shown in the Figures, is made of elastomeric material. These inserts 12 can be used in multiples of inserts interposed between adjacent plies when more than two plies are used in the carcass structure.

The second inserts 12, and third inserts 12, when used, act as a spacer between the adjacent plies. The cords of the plies particularly the radially outer ply is placed in tension when the tire is operated uninflated.

In practice, the rubber compositions for the inserts 12 utilized in this invention for the aforesaid pneumatic tire construction are preferably characterized by physical properties which enhance their utilization in the invention which are, collectively, believed to be a departure from properties of rubber compositions normally used in pneumatic tire sidewalls, particularly the combination of inserts 12 and with plies 10 having a combination of either dissimilar or similar high stiffness yet essentially low hysteresis properties.

In particular, for the purposes of this invention, the aforesaid inserts 12 are designed to have a high degree of stiffness yet also having a relatively low hysteresis for such a degree of stiffness. This enabled the benefits of the change in moduli of the reinforcing cords to be fully appreciated.

The stiffness of the rubber composition for inserts 12 is desirable for stiffness and dimensional stability of the tire sidewall 4. A similar stiffness of the rubber composition for the ply coat for one or more of plies is desirable for overall dimensional stability of the tire carcass, including its sidewalls, since it extends through both sidewalls and across the crown portion of the tire.

However, it is to be appreciated that rubbers with a high degree of stiffness in pneumatic tires normally be expected to generate excessive internal heat during service conditions (operating as tires on a vehicle running under load and/or without internal inflation pressure), particularly when the rubbers stiffness is achieved by a rather conventional method of simply increasing its carbon black content. Such internal heat generation within the rubber composition typically results in a temperature increase of the stiff rubber and associated tire structures that can potentially be detrimental to the useful life of the tire 1.

The hysteresis of the rubber composition is a measure of its tendency to generate internal heat under service conditions. Relatively speaking, a rubber with a lower hysteresis property generates less internal heat under service conditions than an otherwise comparable rubber composition with a substantially higher hysteresis. Thus, in one aspect, a relatively low hysteresis is desired for the rubber composition for the fillers and the plycoat(s) for one or more of the plies 10.

Hysteresis is a term for heat energy expended in a material (e.g., cured rubber composition) by applied work and low hysteresis of a rubber composition is indicated by a relatively high rebound and relatively low tangent delta (Tan Delta) property values.

Accordingly, it is important that the rubber compositions for one or more of the inserts 12 and plycoats for one or more of plies 10 have the properties of both relatively high stiffness and low hysteresis.

The runflat tire containing the inserts of this invention can be built, shaped, molded and cured by various methods that will be readily apparent to those having skill in the art. In general, the runflat tires of this invention can be manufactured using standard techniques with, of course, the exception that the insert therein contains an antireversion agent in addition to the rubbery polymer.

In a preferred embodiment, the insert of this invention is incorporated into a runflat tire of the design described in WO99/65,711, filed on Jun. 19, 1998, the teachings of which are incorporated herein by reference in their entirety. This design relates to a pneumatic radial ply runflat tire having a tread, a carcass comprising a radial ply structure having at least one radial ply, a belt structure located between the tread and the radial ply structure, two sidewalls reinforced by one or more inserts and a tread contour of which the laterally disposed tread ribs are defined by circular curves having large radii of curvature. The outermost ply, or the single ply, is reinforced with inextensible metal cords. The sidewalls each having a rib near the radially outermost regions. The circular curves that define the cross-section contour of the central portions of the tread and the laterally disposed tread rib intersect nontangentially. A circumferentially disposed decoupling groove underlies each respective nontangential locus of points of nontangential intersection of the circular curves that define the cross-section contour of the tread. The circular curve defining the contour of each radially outward-most sidewall rib intersects nontangentially with the circular curve that defines the contour of each laterally disposed tread rib. A second set of decoupling grooves is disposed such that one groove is located circumferentially in each shoulder region where the contour-defining curves intersect nontangentially between each radially disposed sidewall rib and the adjacent laterally disposed tread rib. The lateral-most decoupling grooves between the laterally disposed tread rib and the sidewall rib are circumferential and continuous, or they are circumferential and non-continuous. The decoupling grooves between the laterally disposed tread rib and the central portions of the tread are circumferential and straight in design, or they have a zig-zagged pattern. In a preferred embodiment, the runflat tire is a pneumatic radial having a low-aspect-ratio (in the range of about 30 percent to about 60 percent) design. This embodiment has potential for runflat use in high-performance sports-type vehicles or light trucks. The distinctive feature of this low-aspect-ratio, radial ply runflat pneumatic tire is that runflat tread lift is minimized and that tread footprint is widened during runflat operation.

In another preferred embodiment, the insert of this invention is incorporated into a runflat tire of the design described in WO 00/01543, filed on Jul. 6, 1998, the teachings of which are incorporated herein by reference in their entirety. This design relates to a pneumatic radial ply runflat tire having a tread, a casing with two sidewalls, two radial plies extending from two annular beads and a belt reinforcement structure located radially between the tread and the plies. This runflat sidewall design is characterized by an inner radial ply having metal reinforcement cords and an outer radial ply having organic fiber reinforcement cords. An insert is circumferentially disposed between the inner and outer plies in the region of each sidewall adjacent to the tread shoulder. The insert in each sidewall has properties characterized by high tensile strength, low hysteresis and light weight. The strength and rigidity of the insert can be adjusted by the incorporation of organic fibers aligned more or less in the radial direction within the insert. Metal reinforcing cords in the inner radial ply have properties characterized by a high modulus of elasticity, rigidity with respect to carrying the compressive load on the inserts during runflat operation and good thermal conductivity which distributes heat generated within the inserts during runflat operation. During runflat operation, the high modulus of the reinforcing metal cords of the inner ply carry a substantial compressive load, thereby reducing the compression load carried by the single insert in each sidewall. It should also be noted that, during runflat operation, the outer organic fiber reinforced ply has good flexibility accompanied by high tensile-stress-bearing capacity. In this design, it is preferred for the inner radial ply to have metallic cords at an angle of from about 75° to about 105° with respect to the equatorial plane of the tire. It is also desirable for the insert to be filled with short reinforcing fibers which are aligned primarily in the radial direction to increase the tensile-stress-bearing capacity of the insert.

In still another preferred embodiment of this invention, the insert is incorporated into a runflat tire of the design described in U.S. Pat. No. 5,871,600, the teachings of which are incorporated herein by reference in their entirety. This design relates to a tire having a tread, a belt structure and a carcass. The carcass has a pair of sidewalls with each sidewall having at least one ply or being reinforced with cords having a modulus of at least 10 GPa. In this tire design, at least one ply has a pair of turnup ends wrapped around a pair of inextensible bead cores. Each sidewall structure has at least one insert radially inward of the first ply and a second ply extending at least to each bead core. In this structure, the second ply is spaced from the first ply by a second insert in the sidewall. At least one ply in this tire structure is reinforced with substantially inextensible cords having a modulus greater than the modulus of the other ply. When loaded, this tire has a neutral axis of bending of the sidewall structure closer in proximity to the ply reinforced with cords of a higher modulus than to the ply reinforced with cords of the lower modulus. In a highly preferred embodiment, the first ply has synthetic or textile cords of polyester, nylon, rayon or aramid; while the second ply, most preferably, has aramid cords or metal cords; most preferably, steel cords. The first and second inserts preferably have a cross-sectional shape and material properties selected to enhance inflated ride performance while insuring runflat durability. The inserts can also be reinforced with cords or short fibers.

This invention is illustrated by the following examples that are merely for the purpose of illustration and are not to be regarded as limiting the scope of the invention or the manner in which it can be practiced. Unless specifically indicated otherwise, parts and percentages are given by weight.

### EXAMPLE 1

In this example, 1,6-bis(N,N′-dibenzylthiocarbamoyldithio)-hexane was evaluated in a rubber compound characteristic of that used in an insert of a pneumatic tire. In addition, a control was prepared and tested where no 1,6-bis(N,N′-dibenzylthiocarbamoyldithio)-hexane was used.

Rubber compositions containing the materials set out in Table 1 were prepared in a B R Banbury™ used two separate stages of addition (mixing); namely, one non-productive mix stage (NP) and one productive mix stage (P).

The rubber compositions are identified herein as Samples 1 and 2. Sample 1 is considered herein as being a control without the use of any 1,6-bis(N,N′-dibenzylthio)-hexane.

The samples were cured at about 160° C.

Table 1 provides the behavior and physical properties of the cured Samples 1 and 2.

TABLE 1

| Non-Productive | Sample 1 | Sample 2 |
|---|---|---|
| Natural rubber | 40 | 40 |
| Syndio PBD/cis PBD¹ | 60 | 60 |
| Carbon black | 50 | 50 |
| Antidegradant² | 1 | 1 |
| Antidegradant³ | 2 | 2 |
| Zinc oxide | 5 | 5 |
| Stearic acid | 1 | 1 |
| Productive | | |
| Antidegradant⁴ | 1 | 1 |
| Accelerator⁵ | 2.2 | 2.2 |
| Vulcuren ® VPKA9 188⁶ | 0 | 2 |
| Insoluble sulfur (80%) | 3.5 | 3.5 |
| Compression set, cure 20 m/160° C. (%) | 10.37 | 7.00 |
| Goodrich Blow-out, cure 20 m/160° C. | | |
| Time (min) | 60 | 60 |
| Temperature rise (° C.) | 51 | 29 |
| Goodrich Flex, cure 20 m/160° C. | | |
| Percent | 0.49 | 0.3 |
| Delta T15(° C.) | 16 | 17.1 |
| Zwick rebound Temp 100° C./20m/160° C. | | |
| Rebound value (%) | 79.2 | 79.1 |
| Tan Delta at 10% 100° C. | 0.043 | 0.032 |
| Shore A 23° C. | 78 | 80.6 |
| G′ 1% 100° C. (MPa) | 2.79 | 3.54 |
| Aged Properties (3 days, air. 90° C.) | | |
| Shore A increase versus original | 4.3 | 1.9 |
| 100% modulus (MPa) increase versus original | 2.6 | 1.7 |
| Tear vs. Rayon Ply Treatment | | |
| Force at 23° C. (N) | 110 | 112 |
| Force at 100° C. (N) | 91 | 100 |

¹Ubepol ® VCR 617 which is 17 percent by weight of syndiotactic polybutadiene melting point of 200° C.) polymerized by cobalt CS₂ catalyst system and pre-dispersed in 1,4-cis polybutadiene.
²Polymerized trimethyldihydroquinoline
³N-1,3-dimethyl butyl N′ phenyl paraphenylene diamine
⁴Diarylphenylenediamine
⁵N-tert-butyl-1,2-benzothiozole sulfenimide
⁶1,6-bis(N,N′dibenzylthiocarbamoyldithio)-hexane obtained from Bayer

As can be seen from the above data, use of 1,6-bis(N,N′dibenzylthiocarbamoyldithio)-hexane leads to improved aged property retention, higher stiffness and reduced heat generation with no drawback in adhesion to ply.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A runflat tire which is comprised of a generally toroidal-shaped carcass with an outer circumferential tread, two spaced beads, a radial structure having at least one ply extending from bead to bead and sidewalls extending radially from and connecting said tread to said beads; wherein said tread is adapted to be ground contacting, and said sidewalls contain at least one insert radially inward from said ply and wherein the insert is comprised of a rubbery polymer and 1,6-bis(N,N′-dibenzylthiocarbamoyodithio)-hexane.

2. The runflat tire of claim 1 wherein the insert comprises from 0.1 to 10 phr of 1,6-bis(N,N′-dibenzylthiocarbamoyldithio)-hexane.

3. The runflat tire of claim 1 wherein the insert additionally comprises a cured polydiene rubber from about 10 phr to about 130 phr of a filler.

4. The runflat tire of claim 1 wherein said rubbery polymer is selected from the group consisting of natural rubber, neoprene, polyisoprene, butyl rubber, halobutyl rubber, polybutadiene, styrene-butadiene copolymer, styrene/isoprene/butadiene rubber, isoprene/butadiene rubber, methyl methacrylate-butadiene copolymer, isoprene-styrene copolymer, methyl methacrylate-isoprene copolymer, acrylonitrile-isoprene copolymer, acrylonitrile-butadiene copolymer, EPDM, a rubber coupled with a group IVa metal and mixtures thereof.

5. The runflat tire of claim 1 wherein from 0.5 to 20 phr of a sulfur containing organosilicon compound is present and is of the formula:
Z-Alk-Sₙ-Alk-Z
in which Z is selected from the group consisting of 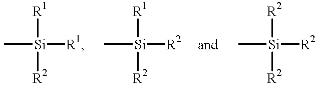
Where R¹ is an alkyl group of 1 to 4 carbon atoms, cyclohexyl or phenyl; R² is alkoxy of 1 to 8 carbon atoms, or cycloalkoxy of 5 to 8 carbon atoms; Alk is a divalent hydrocarbon of 1 to 18 carbon atoms and n is an integer of 2 to 8.

6. The runflat tire of claim 3 wherein said filler is silica.

7. The pneumatic tire of claim 3 wherein the 1,6-bis(N,N′-dibenzylthiocarbamoyldithio)-hexane is present in an amount which is within the range of about 0.5 phr to about 5 phr.

8. The pneumatic tire of in claim 4 wherein the group IVa metal is selected from the group consisting of tin, lead, germanium and silicon.

9. The pneumatic tire of claim 3 wherein the filler is carbon black.

10. The pneumatic tire specified in claim 3 wherein the filler is present at a level which is within the range of about 35 phr to 65 phr.

11. The pneumatic tire of claim 8 wherein the rubber coupled with a Group IVa metal is selected from the group consisting of styrene-butadiene rubber, polybutadiene rubber, polyisoprene rubber, and styrene-isoprene-butadiene rubber.

12. The pneumatic runflat tire of claim 1 wherein said insert is substantially crescent-shaped and is juxtapositioned to and axially inward of at least one of said carcass plies in each of said sidewalls of the tire.

13. The runflat tire of claim 1, wherein said pneumatic radial ply runflat passenger tire having a tread, a casing with two sidewalls, two annular beads, a radial ply structure extending between the two annular beads and a belt structure located between the tread and the radial ply structure, radial ply structure is comprised of: (a) an inner radial ply having metal reinforcement cords capable of supporting compressive loads under runflat operating conditions; (b) an outer radial ply having organic fiber reinforcement cords capable of supporting tensile loads under runflat operating conditions; and (c) an insert having a neutral bending axis therethrough, the insert being circumferentially disposed between the inner and outer radial plies and in a flex area of each sidewall, such that the neutral bending axis is located further from the outer ply under runflat operating conditions for reducing the flexure of the sidewall.
